(19) United States
(12) Patent Application Publication
(10) Pub. No.: US 2024/0365794 A1
(43) Pub. Date: Nov. 7, 2024

(54) PRESSURIZED DOUGH ROLLER

(71) Applicant: Spooner Vicars Bakery Systems, Golborne (GB)

(72) Inventors: Andrew Green, St. Helens (GB); Joseph Green, St. Helens (GB)

(21) Appl. No.: 18/652,698

(22) Filed: May 1, 2024

Related U.S. Application Data
(60) Provisional application No. 63/499,891, filed on May 3, 2023.

(51) Int. Cl. A21C 3/02

(52) U.S. Cl. CPC A21C 3/024

(57) ABSTRACT

One or both of the rollers of a dough rolling apparatus has a pressurized fluid in an interior of the roller.

### CROSS-REFERENCE TO RELATED APPLICATION

This non-provisional application claims the benefit of, and priority to, U.S. Provisional Application No. 63/499,891, entitled PRESSURIZED DOUGH ROLLER, filed on May 3, 2023, which is incorporated by reference in its entirety.

### FIELD

The present disclosure generally relates to dough rollers, and more particularly to commercial scale dough rollers.

### BACKGROUND

Baking dough can be pressed into a flat sheet of dough between two large rollers for preparation of the dough for packaging or baking.

### SUMMARY

In some aspects, the techniques described herein relate to a dough roller apparatus including: a first roller having an interior; a second roller positioned vertically above or below the first roller; and a positive pressure source fluidly coupled to the interior of the first roller, wherein the positive pressure source is configured to provide a pressurized fluid to the interior of the first roller so as to fill the interior with the pressurized fluid, wherein the pressurized fluid has a pressure greater than 1 bar (e.g., 100 bar to 150 bar).

In some aspects, the techniques described herein relate to a dough roller apparatus including: a first roller having an interior filled with a pressurized fluid; a second roller positioned vertically above or below the first roller, wherein the pressurized fluid has a pressure greater than 1 bar (e.g., 100 bar to 150 bar).

In some aspects, the techniques described herein relate to a process for pressurizing a dough roller: pressurizing an interior of a first roller of a dough roller apparatus to a first pressure; isolating the interior at the first pressure (e.g., by actuating a valve fluidly connected with the interior from an open position to a closed position); and rolling, via the first roller, a mass of dough into a flat dough sheet while the interior of the first roller is at the first pressure.

In some aspects, the techniques described herein relate to a process for depressurizing a dough roller: rolling, via the first roller, a mass of dough into a flat sheet while an interior of the first roller contains a pressurized fluid at a first pressure; stopping the rolling; and actuating a valve fluidly connected with the interior from a closed position to an open position so that the pressurized fluid changes from the first pressure to a second pressure, wherein the second pressure is less than the first pressure.

In some aspects, the techniques described herein relate to a process for operating a pressurized dough roller, the process including: rolling, via a first roller, a mass of dough into a flat dough sheet while an interior of the first roller is filled with a pressurized fluid at a first pressure, wherein the first pressure is greater than 1 bar (e.g., 100 bar to 150 bar).

Other technical features may be readily apparent to one skilled in the art from the following figures, descriptions and claims.

### BRIEF DESCRIPTION OF THE DRAWINGS

For a more complete understanding of this disclosure, reference is now made to the following description, taken in conjunction with the accompanying drawings, in which:

FIG. 1 illustrates a perspective view of a dough roller apparatus having a first roller positioned above a second roller.

FIG. 2 illustrates a side elevational view of a pressurized dough roller apparatus having the dough roller apparatus of FIG. 1.

FIG. 3 illustrates an end elevational view of the apparatus depicted in FIG. 2.

FIG. 4 illustrates an end elevational view of the cylindrical body of the roller, showing he thickness t2 of the cylinder.

FIG. 5 is a left end view of the apparatus depicted in FIGS. 1 and 2, with representative dimensions in mm.

FIG. 6 is a top view of the apparatus depicted in FIGS. 1 and 2, with a representative length dimension of the roller axle in mm.

FIG. 7 is an end view of the apparatus depicted in FIGS. 1 and 2, with representative length dimensions in mm.

FIG. 8 is a schematic illustration of prior art rollers producing dough of non-uniform thickness between the two rollers.

FIG. 9 is a schematic illustration of the effect on the rollers of pressurizing the interior with a pressurized fluid to produce dough of uniform thickness between the two rollers.

### DETAILED DESCRIPTION

“Interior” when used to describe the inside of a dough roller refers to a cavity inside the cylindrical body of the dough roller that can be filled with a pressurized fluid disclosed herein. The shape and contour of the cavity is not limited by this disclosure. “Positive pressure source” when used to describe the pressure source excludes vacuum pressures.

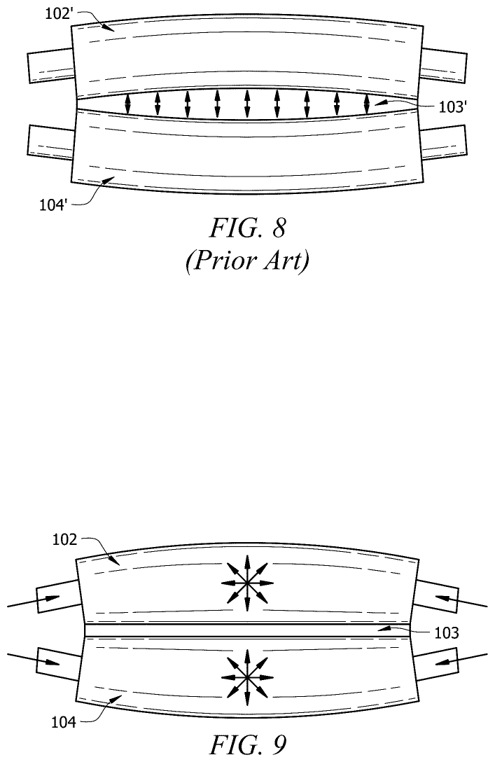

It has been found that when pressing dough into a thin sheet (e.g., less than 5 mm thickness of the dough sheet) after passing a mass of dough between two vertically-oriented commercial-scale rollers (one above the other), the reaction force from the dough being compressed between the rollers causes deflection/bending of one or both of the rollers along the longitudinal axis/axes and results in a non-uniform dough sheet thickness. A schematic example of the problem is depicted in FIG. 8, which depicts dough of non-uniform thickness 103′ between the two rollers 102′ and 104′.

The solution we have found is to pressurize the interior of one or both of the rollers. Doing so flattens the part of the roller that is in contact with the dough. A schematic example of the effect on the rollers of pressurizing the interior with a pressurized fluid 101 is depicted in FIG. 9, which depicts dough of uniform thickness 103 between the two rollers 102 and 104.

Commercial scale rollers can be manufactured to have a cavity on the inside of the roller. The interior of the roller can be sealed by the connection of end members with the cylindrical body of the roller, with any additional mechanism for sealing such as welds, gaskets, an adhesive sealant, or combinations thereof. The seal is sufficient to prevent the pressurized fluid (e.g., air, nitrogen, water, hydraulic oil) from leaking from the interior of the roller after pressurization and isolation (from the positive pressure source) of the pressurized interior.

Commercial scale rollers can be manufactured to have a cavity on the inside of the roller. The interior of the roller can be sealed by the connection of end members with the cylindrical body of the roller, with any additional mechanism for sealing such as welds, gaskets, an adhesive sealant, or combinations thereof. The seal is sufficient to prevent the pressurized fluid (e.g., air, nitrogen, water, hydraulic oil) from leaking from the interior of the roller after pressurization and isolation (from the positive pressure source) of the pressurized interior.

The disclosed invention pressurizes the interior of one or more of the rollers to achieve a dough sheet of uniform thickness between the rollers. The pressurized dough roller is particularly useful for dough sheet thickness of less than 5, 4, 3, 2, or 1 mm.

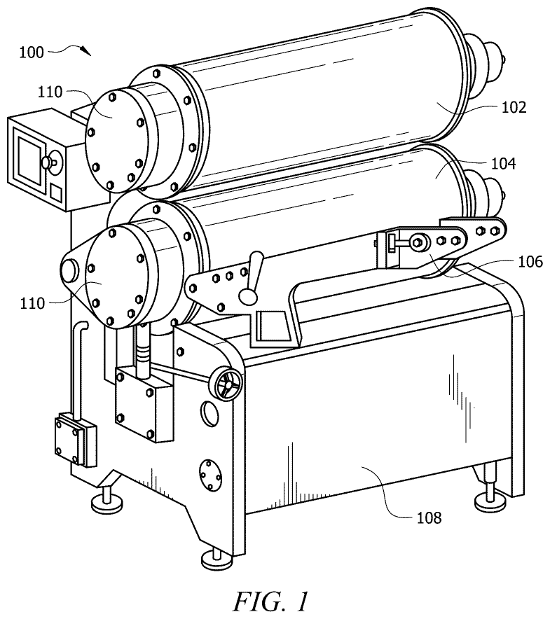

FIG. 1 is a perspective view of a dough roller apparatus 100 having a first roller 102 positioned above a second roller 104. A mass of dough is positioned on one side of the rollers 102 and 104, and motors 110 turn the rollers in opposite directions along their longitudinal axes so as to pull the dough mass between the rollers 102 and 104, where the dough is compressed into a dough sheet having a thickness that is equal to the thickness of the space between the contact surfaces of the rollers 102 and 104. The dough sheet then passes onto the conveyor 106 and is conveyed further along the apparatus and process. A frame 108 holds the first roller 102 and the second roller 104 in position.

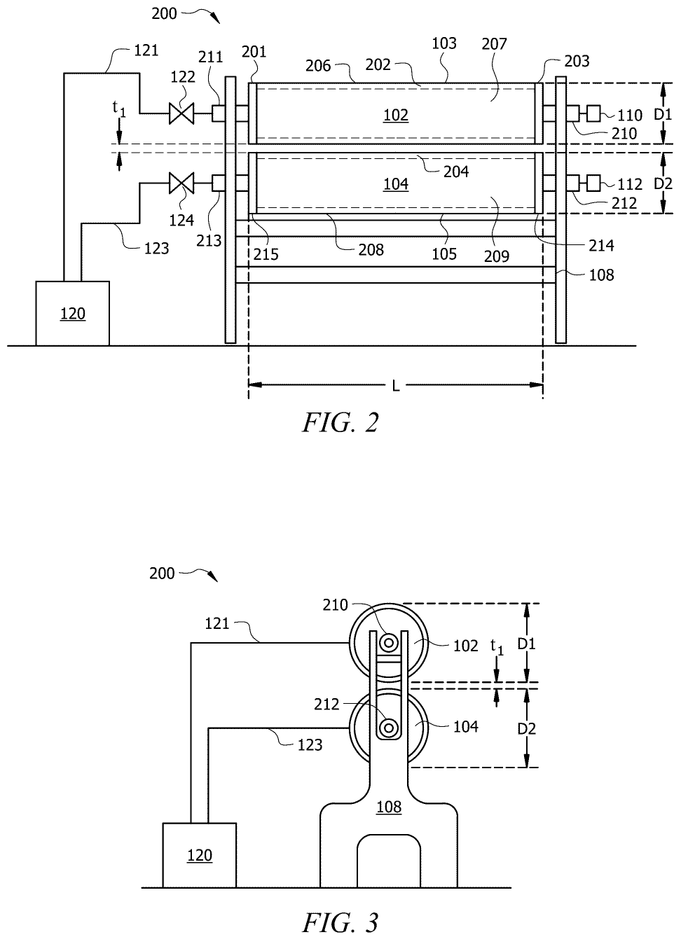

FIG. 2 is a side elevational view of a pressurized dough roller apparatus 200 having the dough roller apparatus 100 of FIG. 1. The disclosed apparatus 200 can include a first roller 102, a second roller 104, and a positive pressure source 120 fluidly connected to an interior of the first roller 102, to an interior of the second roller 104, or to the interior of the first roller 102 and to the interior of the second roller 104. The positive pressure source 120 is configured to supply a pressure in a range of from about 100 bar to about 150 bar to the interior of the first roller 102, to the interior of the second roller 104, or to the interior of the first roller 102 and to the interior of the second roller 104. The first roller 102 and the second roller 104 are spaced apart a distance (e.g., less than 5 mm so that the dough can pass between a contact surface 103 of the first roller 102 and a contact surface 105 of the second roller 104.

The first roller 102 has a cylindrical body 206 and end members 201 and 203 on each end of the cylindrical body 206. The first roller 102 has an interior 207 defined by a wall 202 of the cylindrical body 206. The first roller 102 also has axle portions 210 and 211 that are held by the frame 108 of the apparatus 200. The axle portions 210 and 211 can be part of a larger axle that extends through the interior 207 of the cylindrical body 206, where the axle portion 210 is connected to the end member 203 and the axle portion 211 is connected to the end member 201; alternatively, the axle portions 210 and 211 do not extend through the interior 207 and are connected to the end members 201 and 203, respectively. The wall 202 of the cylindrical body 206 can be of uniform thickness along the length L of the cylindrical body 206; alternatively, the wall 202 of the cylindrical body 206 can be of non-uniform thickness along the length L of the cylindrical body 206 (e.g., the inner surface of the wall 202 can have a cross-sectional profile of an elliptical arc). The axle portion 210 is mechanically connected to a motor 110, and the motor 110 is configured to rotate the first roller 102 along a longitudinal axis of the first roller 102. The first roller 102 can have an outer diameter D1 in a range of from 200 mm to 1000 mm; alternatively, from 300 mm to 600 mm; alternatively, about 300, 350, 400, 450, 500, 550, or 600 mm. The first roller 102 can have a length L of from 1000 mm to 5000 mm; alternatively, from 1000 mm to 3000 mm; alternatively, from 1000 mm to 2000 mm; alternatively, from 1500 mm to 2000 mm; alternatively, about 1500, 1550, 1600, 1650, 1700, 1750, 1800, 1850, 1900, 1950, or 2000 mm. A thickness of the wall 202 at the center of the first roller 102 (the center of wall 202 in the view of FIG. 2) can be in a range of from 10 mm to 100 mm; alternatively, from 20 mm to 60 mm; alternatively, from 30 mm to 50 mm; alternatively, about 30, 35, 40, 45, or 50 mm.

The second roller 104 has a cylindrical body 208 and end members 214 and 215 on each end of the cylindrical body 208. The second roller 104 has an interior 209 defined by a wall 204 of the cylindrical body 208. The second roller 104 also has axle portions 212 and 213 that are held by the frame 108 of the apparatus 200. The axle portions 212 and 213 can be part of a larger axle that extends through the interior 209 of the cylindrical body 208, where the axle portion 212 is connected to the end member 214 and the axle portion 213 is connected to the end member 215; alternatively, the axle portions 212 and 213 do not extend through the interior 209 and are connected to the end members 214 and 215, respectively. The wall 204 of the cylindrical body 208 can be of uniform thickness along the length L of the cylindrical body 208; alternatively, the wall 204 of the cylindrical body 208 can be of non-uniform thickness along the length L of the cylindrical body 208 (e.g., the inner surface of the wall 204 can have a cross-sectional profile of an elliptical arc). The axle portion 212 is mechanically connected to a motor 110, and the motor 110 is configured to rotate the second roller 104 along a longitudinal axis of the second roller 104. The second roller 104 can have an outer diameter D2 in a range of from 200 mm to 1000 mm; alternatively, from 300 mm to 600 mm; alternatively, about 300, 350, 400, 450, 500, 550, or 600 mm. The second roller 104 can have a length L of from 1000 mm to 5000 mm; alternatively, from 1000 mm to 3000 mm; alternatively, from 1000 mm to 2000 mm; alternatively, from 1500 mm to 2000 mm; alternatively, about 1500, 1550, 1600, 1650, 1700, 1750, 1800, 1850, 1900, 1950, or 2000 mm. A thickness of the wall 204 at the center of the second roller 104 (the center of wall 204 in the view of FIG. 2) can be in a range of from 10 mm to 100 mm; alternatively, from 20 mm to 60 mm; alternatively, from 30 mm to 50 mm; alternatively, about 30, 35, 40, 45, or 50 mm.

The apparatus 200 also includes a positive pressure source 120 fluidly coupled to the interior 207 of the first roller 102, to the interior 209 of the second roller 104, or to both the interior 207 of the first roller 102 and to the interior 209 of the second roller 104. OR BOTH The positive pressure source 120 can be embodied as an air compressor, a gas cylinder, or a hydraulic fluid pump, for example.

To pressurize the first roller 102, a conduit 121 can fluidly couple the positive pressure source 120 to the interior 207 of the first roller 102. The conduit 121 can include a valve 122 that can be actuated between an open position and a closed position. The conduit 121 can have an end connected to the positive pressure source 120 and an opposite end connected to the axle portion 211 or to the end member 201. If connected to the axle portion 211, then axle portion 211 has a fluid passageway or interior through which the pressurized fluid flows into the interior 207 of the first roller 102. If connected to the end member 201, then the end member 201 has a hole or passageway formed therein and through which the pressurized fluid flows into the interior 207 of the first roller 102.

To pressurize the second roller 104, a conduit 123 can fluidly couple the positive pressure source 120 to the interior 209 of the second roller 104. The conduit 123 can include a valve 124 that can be actuated between an open position and a closed position. The conduit 123 can have an end connected to the positive pressure source 120 and an opposite end connected to the axle portion 213 or to the end member 215. If connected to the axle portion 213, then axle portion 213 has a fluid passageway or interior through which the pressurized fluid flows into the interior 209 of the second roller 104. If connected to the end member 215, then the end member 215 has a hole or passageway formed therein and through which the pressurized fluid flows into the interior 209 of the second roller 104.

The positive pressure source 120 is configured to supply a pressurized fluid (e.g., air, nitrogen, water, hydraulic oil, or combinations thereof) at a pressure in a range of from about 100 bar to about 150 bar. The pressure can be selected depending on the toughness of the dough being processed.

FIG. 3 illustrates an end elevational view of the apparatus 200. A different view of the frame 108 holding the axle portions 210 and 212 of the rollers 102 and 104 can be seen. While frame 108 is illustrated as shown in FIGS. 2 and 3, it is contemplated that frame 108 can have any configuration and structure known in the art with the aid of this disclosure, such as that shown in FIG. 1. In aspects, the outer diameter D1 of the first roller 102 and the outer diameter D2 of the second roller 104 can be the same. Alternatively, the outer diameter D1 of the first roller 102 can be greater than the outer diameter D2 of the second roller 104; alternatively, the outer diameter D1 of the first roller 102 can be less than the outer diameter D2 of the second roller 104.

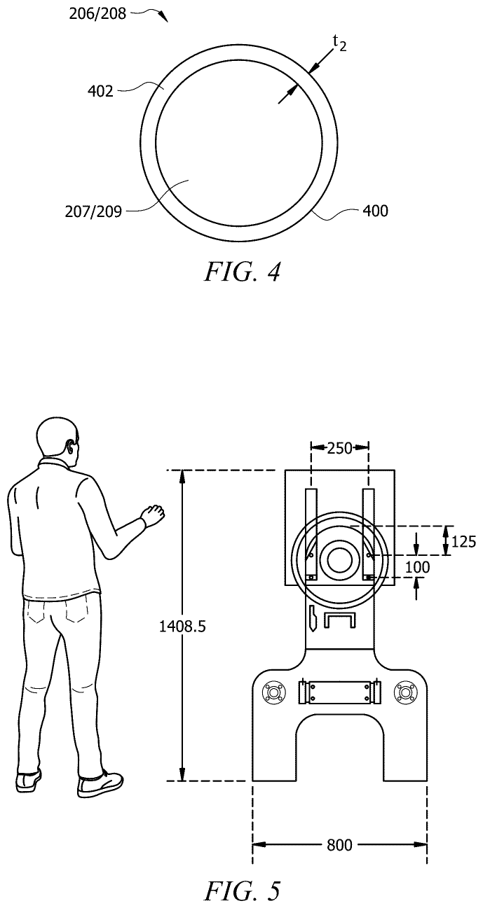

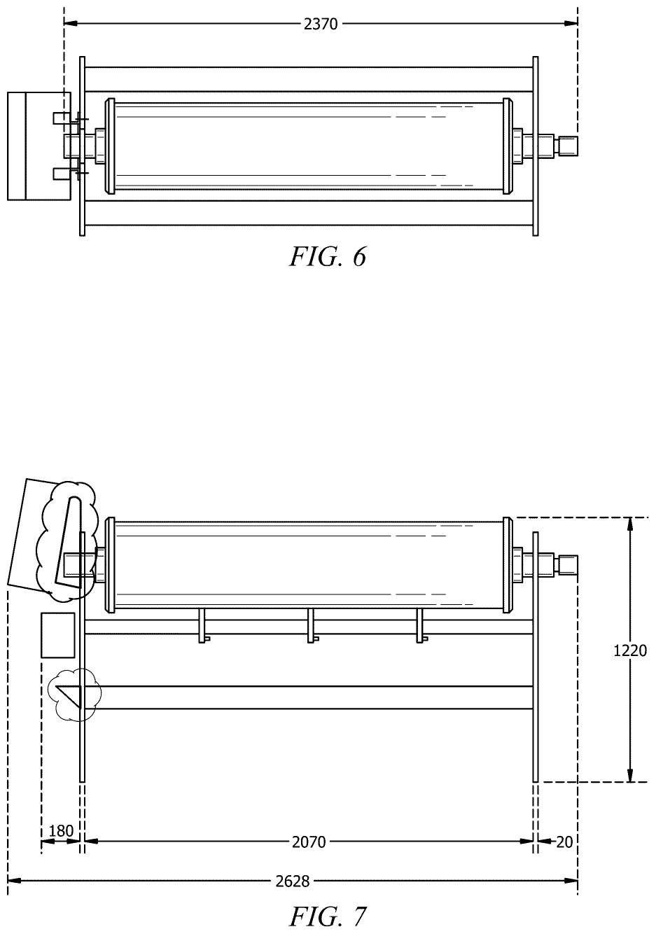

FIG. 4 illustrates an end elevational view of the cylindrical body 206/208 of the roller 102/104. The thickness t1 of the wall 402 can be seen, having a thickness disclosed herein. The contact surface 400 is circular in cross-section. The interior 207/208 can be filled with the pressurized fluid for operation of dough rolling.

A process can include conveying a mass of dough between a first roller 102 and a second roller 104, wherein a pressure inside the first roller 102, a pressure inside the second roller 104, or both the pressure inside the first roller 102 and the pressure inside the second roller 104 is/are in a range of greater than 1 bar to 150 bar.

A process for pressurizing a dough roller 102/104, can include: pressurizing an interior 207/209 of a first roller 102/104 of a dough roller apparatus 200 to a first pressure with a pressurized fluid; isolating the interior 207/209 at the first pressure (e.g., by actuating a valve 122/124 fluidly connected with the interior 207/209 from an open position to a closed position); and rolling, via the first roller 102/104, a mass of dough into a flat dough sheet while the pressurized fluid in the interior 207/209 of the first roller 102/104 is at the first pressure. The first pressure can be greater than 1 bar to about 150 bar.

A process for depressurizing a dough roller 102/104, can include: rolling, via the first roller 102/104, a mass of dough into a flat sheet while an interior 207/209 of the first roller 102/104 contains a pressurized fluid at a first pressure; stopping the rolling; and actuating a valve 122/124 fluidly connected with the interior 207/209 from a closed position to an open position so that the pressurized fluid changes from the first pressure to a second pressure, wherein the second pressure is less than the first pressure. The first pressure can be greater than 1 bar to about 150 bar.

A process for operating a pressurized dough roller 102/104, the process comprising: rolling, via a first roller 102/104, a mass of dough into a flat dough sheet while an interior 207/209 of the first roller 102/104 is filled with a pressurized fluid at a first pressure, wherein the first pressure is greater than 1 bar (e.g., 100 bar to 150 bar).

Advantages include:

Reduction in cross band weight variation of dough sheet.

Increased accuracy of product dough piece weights/reduced product give away.

Increased productivity due to reduction in out-of-spec product rejection.

Reduced interaction required by Operators

Infinitely variable roller profiles, easily adjustable to suit ALL product types/final dough sheet thicknesses.

Effective on even the widest of lines.

Dough sheet transfer points are in no way impacted.

Can accommodate both wide and narrow lengths L of the rollers 102 and 104 processing extremely tough dough types.

Can retrofit a pressure source package on existing dough roller apparatuses

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A dough roller apparatus comprising:
a first roller having an interior;
a second roller positioned vertically above or below the first roller; and
a positive pressure source fluidly coupled to the interior of the first roller, wherein the positive pressure source is configured to provide a pressurized fluid to the interior of the first roller so as to fill the interior with the pressurized fluid, wherein the pressurized fluid has a pressure greater than 1 bar.

2. A dough roller apparatus comprising:
a first roller having an interior filled with a pressurized fluid;
a second roller positioned vertically above or below the first roller, wherein the pressurized fluid has a pressure greater than 1 bar.

3. A process for pressurizing a dough roller:
pressurizing an interior of a first roller of a dough roller apparatus to a first pressure;
isolating the interior at the first pressure above 1 bar; and
rolling, via the first roller, a mass of dough into a flat dough sheet while the interior of the first roller is at the first pressure.

4. A process for depressurizing a dough roller:
rolling, via a first roller of a dough rolling apparatus, a mass of dough into a flat sheet while an interior of the first roller contains a pressurized fluid at a first pressure above 1 bar;
stopping the rolling; and
actuating a valve fluidly connected with the interior from a closed position to an open position so that the pressurized fluid changes from the first pressure to a second pressure, wherein the second pressure is less than the first pressure.

5. A process for operating a pressurized dough roller, the process comprising:
rolling, via a first roller, a mass of dough into a flat dough sheet while an interior of the first roller is filled with a pressurized fluid at a first pressure, wherein the first pressure is greater than 1 bar.

6. The dough roller apparatus of claim 1, wherein the pressure is between 100 bar and 150 bar.

7. The dough roller apparatus of claim 2, wherein the second roller has a pressure between 100 bar and 150 bar.

8. The process for pressurizing a dough roller of claim 3, wherein the first pressure is between 100 bar and 150 bar.

9. The process for depressurizing a dough roller of claim 4, wherein the first pressure is between 100 bar and 150 bar.

10. The process for operating a pressurized dough roller of claim 5, wherein the first pressure is between 100 bar and 150 bar.
